(19) United States
(12) Patent Application Publication
(10) Pub. No.: US 2013/0239410 A1
(43) Pub. Date: Sep. 19, 2013

(54) METHOD FOR MANUFACTURING HEAT PIPE

(71) Applicant: FOXCONN TECHNOLOGY CO., LTD., New Taipei (TW)

(72) Inventors: MING-HSIU CHUNG, New Taipei (TW); NIEN-TIEN CHENG, New Taipei (TW)

(73) Assignee: FOXCONN TECHNOLOGY CO., LTD., New Taipei (TW)

(21) Appl. No.: 13/691,954

(22) Filed: Dec. 3, 2012

(30) Foreign Application Priority Data
Mar. 16, 2012 (TW) 101109128

(51) Int. Cl. F28D 15/02; B23P 15/26

(52) U.S. Cl. CPC F28D 15/02; B23P 15/26
USPC 29/890.032

(57) ABSTRACT

An exemplary method for manufacturing a heat pipe is disclosed. A mixture including metal powder and organic cement is made. The mixture is then injected to a mold to form two blanks. The two blanks are debinded to remove the organic cement therefrom. The two blanks are further sintered to join together and form a tube. A working liquid is filled in the tube from an open end thereof. The tube is then vacuumed to exhaust air therein. The open end of the tube is finally sealed to form a hermetic space in the tube.

### BACKGROUND

1. Technical Field

The disclosure generally relates to heat pipes and, particularly, to a method for manufacturing a heat pipe.

2. Description of Related Art

With the continuing development of electronic technology, electronic components are made to have smaller sizes and higher frequencies. However, issues of heat dissipation are also raised accordingly. In order to cool the electronic components, heat dissipation devices, such as heat pipes, are used to dissipate heat from the electronic components.

A typical heat pipe includes a tube, a wick structure received in the tube, and a working fluid sealed in the tube. The heat pipe is generally manufactured by cutting a long pipe into several tubes, forming a wick structure in each tube, filling working liquid in each tube, vacuuming each tube, and sealing each tube. Some types of the heat pipes may further be bended or flattened to have predetermined shapes. The manufacturing processes of the heat pipes may be difficult. Furthermore, during flattening or bending, the wick structure may be destroyed or even dropped from the inner wall of the tube, thereby affecting the heat transferring capability of the heat pipe.

What is needed, therefore, is a means which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is an isometric view of a heat pipe of manufactured by a method in accordance with a first embodiment of the present disclosure.

FIG. 2 is a cross section of the heat pipe of FIG. 1, taken along line II-II thereof.

FIG. 3 shows a semi-finished product of the heat pipe of FIG. 2.

FIG. 4 is similar to FIG. 3, but showing a semi-finished product of a heat pipe manufactured by a method in accordance with a second embodiment of the present disclosure.

FIG. 5 is similar to FIG. 3, but showing a semi-finished product of a heat pipe manufactured by a method in accordance with a third embodiment of the present disclosure.

FIG. 6 is similar to FIG. 3, but showing a semi-finished product of a heat pipe manufactured by a method in accordance with a fourth embodiment of the present disclosure.

FIG. 7 is similar to FIG. 3, but showing a semi-finished product of a heat pipe manufactured by a method in accordance with a fifth embodiment of the present disclosure.

### DETAILED DESCRIPTION

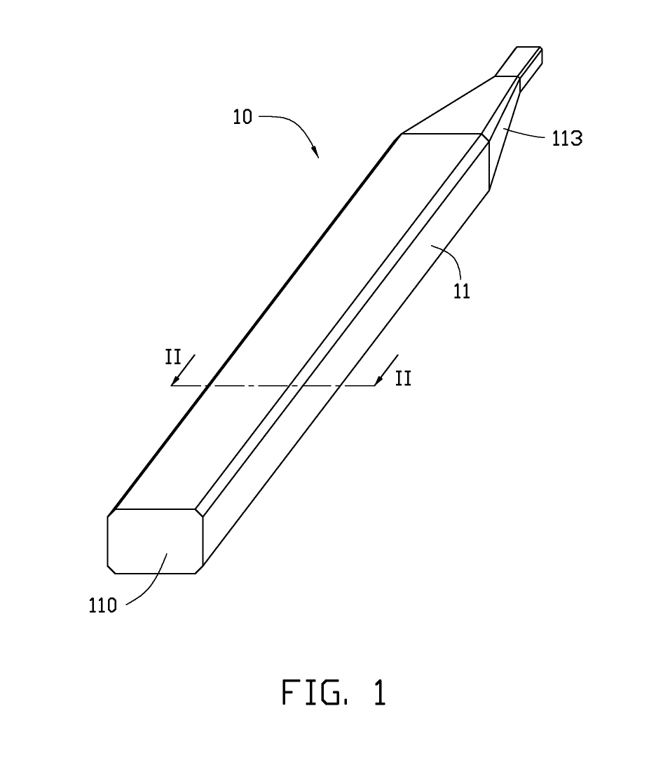

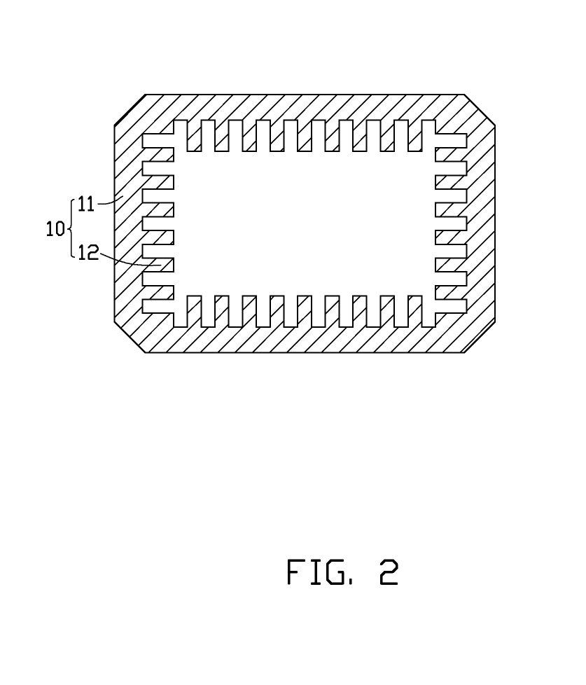

Referring to FIGS. 1-2, a heat pipe 10 manufactured by a method in accordance with a first embodiment of the present disclosure is shown. The heat pipe 10 includes a tube 11, a wick structure 12 formed in the tube 11, and a working liquid (not shown) received in the tube 11.

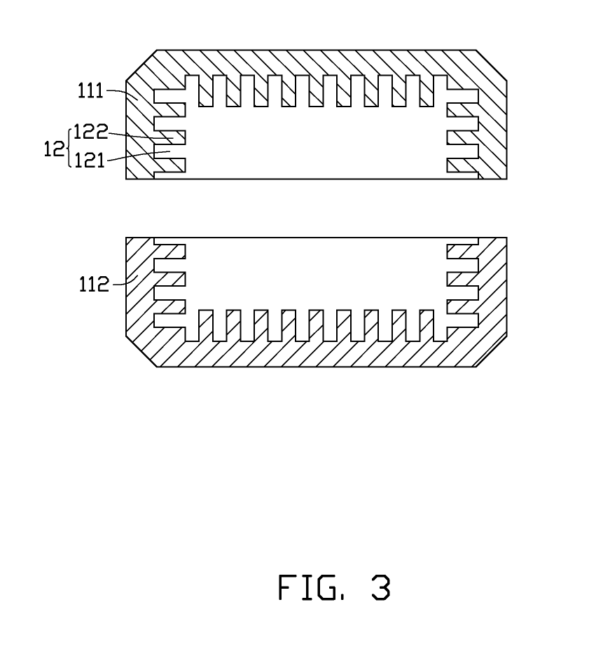

The tube 11 is made by sintering an upper blank 111 and a lower blank 112 together as shown in FIG. 3. In detail, a kind of mixture is firstly provided. The mixture includes metal powder blended with organic cement. The metal powder may be made of materials selected from copper, aluminum, copper alloy, aluminum alloy, Fe—Ni alloy, stainless steel, titanium alloy, nickel alloy, aluminum oxide, zirconium oxide and so on. A diameter of the particulate of the metal powder may range from 0.5 to 20 μm, wherein 5˜15 μm is preferable for this embodiment. The organic cement is made of flowable resin materials, such as polyethylene, vinyl acetate and so on. A volume ratio of the metal powder to the organic cement is 2:3˜7:3.

The metal powder and the organic cement are mixed by a mixing roll, to thereby form the mixture. The mixture is a plastic fluid where the metal powder is uniformly distributed in the organic cement. Alternatively, the plastic fluid may be further granulated or grinded according to requirements of next manufacturing processes.

The plastic fluid is further injected into a mold to form a plurality of blanks 111, 112. In this embodiment, the tube 11 is constructed by joining the upper and lower blanks 111, 112 together. Each of the upper and lower blanks 111, 112 has a U-shaped cross section. Each of the upper and lower blanks 111, 112 has a wick structure 12 formed on an inner face thereof. The wick structure 12 includes a plurality of protrusions 122 and a plurality of grooves 121 between the protrusions 122. The protrusions 122 of the wick structure 12 may be formed with each of the upper and lower blanks 111, 112 as a single monolithic piece. Alternatively, the protrusions 122 may be attached on the inner face of the upper and lower blanks 111, 112 after the blank 111, 112 is molded.

The upper and lower blanks 111, 112 are further debinded to release the organic cement from the sintered metal powder. In this embodiment, the upper and lower blanks 111, 112 are debinded under a high temperature so that the organic cement is heated to gas escaping from the metal powder. Alternatively, other treating methods, such as siphonage-thermal debinding or solvent-thermal debinding, may also be used in this step.

The upper and lower blanks 111, 112 are finally sintered to join together. Gaps between the particulates of the metal powder are eliminated during heating the metal powder under a high temperature. Thus, the upper and lower blanks 111, 112 are firmly fixed to each other to form the entire tube 11. The tube 11 has a closed end 110 and an open end 113 opposite to the closed end 110. The open end 113 gradually shrinks in a direction away from the closed end 110. The tube 11 may be further machined by thermal treatment or surface treatment to improve an appearance thereof.

The tube 11 is filled with the working liquid from the open end 113. The working liquid may be selected from materials such as water, alcohol, acetone or the like. The tube 11 is then vacuumed through the open end 113 to exhaust air in the tube 11. Finally, the open end 113 of the tube 11 is sealed to form a hermetic space within the tube 11.

The tube 11 manufactured by this method can directly form a predetermined shape. Thus, the typical manufacturing processes for shaping the conventional heat pipe, such as cutting, bending or flattening, are undesired for the heat pipe 10 of the present disclosure. Accordingly, the heat pipe 10 of the present disclosure can be made more easily. Furthermore, the simplification of the manufacturing processes of the present disclosure can protect the wick structure 12 of the heat pipe 10 from being destroyed or even dropped from the tube 11 during bending or flattening. Therefore, the quality of the heat pipe 10 is improved.

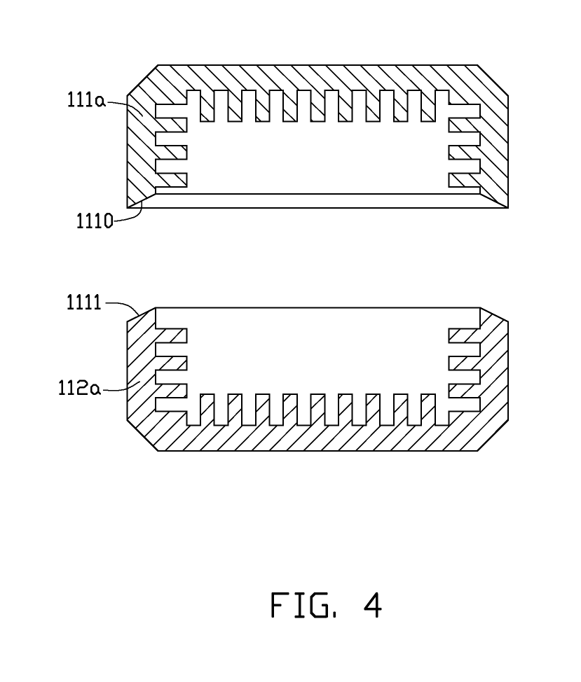

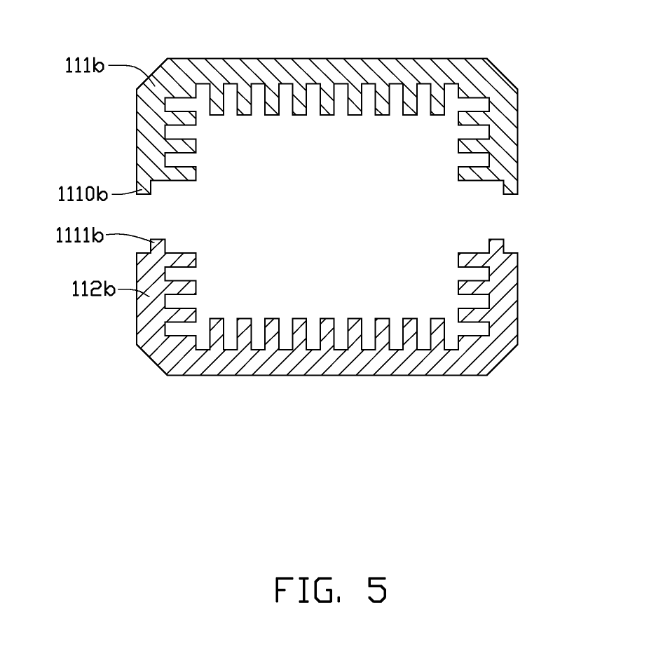

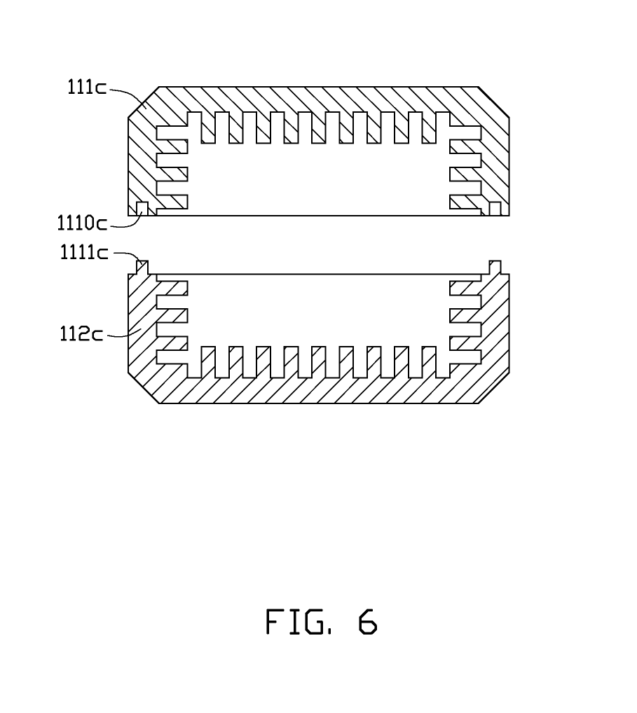

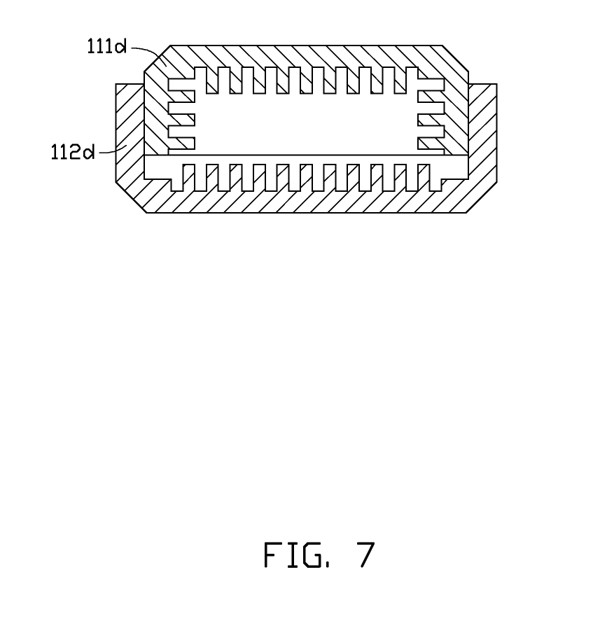

In order to facilitate joint of the upper and lower blanks 111, 112 before sintering, some positioning structures may be formed on the upper and lower blanks 111, 112. For example, FIG. 4 shows an upper blank 111a forming an inclined bottom face 1110 and a lower blank 112a forming an inclined top face 1111. The inclined top face 1111 of the lower blank 112a matches the inclined bottom face 1110 of the upper blank 111a, whereby the upper and lower blanks 111a, 112a can be positioned relative to each other more conveniently. FIG. 5 shows an upper blank 111b forming an annular outer protrusion 1110b on a bottom face thereof and a lower blank 112b forming an annular inner protrusion 1111b on a top face thereof. The annular outer protrusion 1110b of the upper blank 111b can fittingly surround the annular inner protrusion 1111b of the lower blank 112b to position the upper and lower blanks 111b, 112b together. FIG. 6 shows an upper blank 111c defining an annular groove 1110c in a bottom face thereof and a lower blank 112c forming an annular protrusion 1111c on a top face thereof. The annular protrusion 1111c of the lower blank 112c can be received in the groove 1110c of the upper blank 111c to position the upper and lower blanks 111c, 112c together. FIG. 7 shows an upper blank 111d having an outer diameter equal to or slightly less than an inner diameter of a lower blank 112d. Thus, the upper blank 111d can be fittingly received in the lower blank 112d to position the upper and lower blanks 111d, 112d together.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a heat pipe, comprising:
making a mixture of metal powder and organic cement;
injecting the mixture to form two blanks, each of the two blanks having a wick structure formed on an inner face thereof;
debinding the two blanks to release the organic cement from the metal powder of the two blanks;
joining the two blanks together to form a tube, the tube comprising an open end and a closed end;
filling a working liquid in the tube through the open end;
pumping air out the tube from the open end to create a vacuum in an inner space of the tube; and
sealing the open end of the tube.

2. The method of claim 1, wherein the mixture is a plastic liquid in which the metal powder is uniformly distributed in the organic cement.

3. The method of claim 2, further comprising granulating or grinding the plastic liquid before the step of injection.

4. The method of claim 1, wherein the metal powder is mixed with the organic liquid by a mixing roll.

5. The method of claim 1, wherein the metal powder is made of materials selected from metal, metal oxide and metal alloy.

6. The method of claim 1, wherein the metal powder has a particulate diameter ranging between 0.5 and 20 μm.

7. The method of claim 1, wherein the metal powder has a particulate diameter ranging between 5 and 15 μm.

8. The method of claim 1, wherein the organic cement is made of a flowable resin.

9. The method of claim 8, wherein the organic cement is one of polyethylene and vinyl acetate.

10. The method of claim 1, wherein a volume ratio of the metal powder to the organic cement ranges from 2:3 to 7:3.

11. The method of claim 1, wherein the wick structure and a corresponding blank of the two blanks are made as a single monolithic piece.

12. The method of claim 11, wherein the wick structure comprises a plurality of protrusions and a plurality of gaps, each of the plurality of protrusions is adjacent to each of the plurality of gaps.

13. The method of claim 1, wherein the step of joining the two blanks is by sintering the two blanks together.

14. The method of claim 1, wherein the step of injecting to form the two blanks further comprises making positioning structures in each of the two blanks that match each other.

15. The method of claim 1, wherein the step of injecting to form the two blanks further comprises making an inclined bottom face on one of the two blanks, and an inclined top face on another of the two blanks, the inclined top face is configured to contact with the inclined bottom face.

16. The method of claim 1, wherein the step of injecting to form the two blanks further comprises forming an annular outer protrusion on one of the two blanks, and forming an annular inner protrusion on another one of the two blanks, the annular inner protrusion is configured to be surrounded by the annular outer protrusion.

17. The method of claim 1, wherein the step of injecting to form the two blanks further comprises forming a groove on one of the two blanks, and forming a protrusion on another one of the two blanks, the protrusion is configure to be inserted into the groove.

18. The method of claim 1, wherein the step of injecting to form the two blanks further comprises making an outer diameter of one of the two blanks has equal to an inner diameter of another one of the two blanks, and making the one of the two blanks configured to be fittingly received in the another one of the two blanks.
